(19) United States
(12) Patent Application Publication
(10) Pub. No.: US 2022/0198321 A1
(43) Pub. Date: Jun. 23, 2022

(54) Data Validation Systems and Methods

(71) Applicant: FMR LLC, Boston, MA (US)

(72) Inventor: Michael Moynihan, Boston, MA (US)

(21) Appl. No.: 17/128,395

(22) Filed: Dec. 21, 2020

(51) Int. Cl. G06N 20/00; G06K 9/62; G06F 40/205; G06F 40/30; G06Q 40/06

(52) U.S. Cl. CPC G06N 20/00; G06K 9/6215; G06K 9/628; G06Q 40/06; G06F 40/205; G06F 40/30; G06K 9/6262

(57) ABSTRACT

A computer-implemented method is provided for validating input data from a third-party vendor. The method includes receiving, by a computing device, a plurality of prospectuses from a plurality of third-party entities and generating, by the computing device, a trained machine learning model using the plurality of prospectuses. The method also includes applying, by the computing device, the trained machine learning model on the input data to predict a classification label for the input data and generate a confidence level for the prediction.

### TECHNICAL FIELD

This application relates generally to systems, methods and apparatuses, including computer program products, for validating input data from a third-party vendor.

### BACKGROUND

A data-driven organization, such as a financial institution, relies heavily on data (e.g., financial entity data) from third party vendors (e.g. Morningstar, Bloomberg, etc.), where the data constitutes a critical input into the organization's analytical process. For example, a typical financial institution receives millions of data points related to financial entities (mutual funds, ETFs, stocks, etc.) on a daily basis from market data providers. These data points are a critical part of the overall investment process. Therefore, being able to verify and validate the data is extremely important.

Historically a data validation process in a financial institution involves creating reports of those financial entities for which data has changed, such as a change in the investment category of a financial entity. These reports are then reviewed by a data analyst who researches each financial entity and makes a qualitative judgement regarding whether each change is valid. This is a manual, time consuming, and error-prone process that may need to be performed daily, as data from third-party vendors can change daily. In addition, the expertise needed to research an entity is significant. A data analyst may require hours of training before he/she has the ability to perform the validation task independently. Further, such a validation process occurs asynchronously to the portfolio construction process. Therefore data analysts do not typically know if the instrument associated with changed data can be a part of the portfolio construction process and/or impact the construction of portfolios for clients.

### SUMMARY

The present invention features systems and methods for a data validation system that is configured to automatically and systematically process input data (e.g., prospectus information) from third party vendors (e.g., financial entities) and use this information to train a multiclass classification model, where the model is subsequently used to verify data changes associated with the financial entities.

In one aspect, the present application features a computer-implemented method for validating input data from a third-party vendor. The method includes receiving, by a computing device, a plurality of prospectuses from a plurality of third-party entities. The method also includes (i) generating, by the computing device, a trained machine learning model using the plurality of prospectuses and (ii) applying, by the computing device, the trained machine learning model on the input data to predict a classification label for the input data and generate a confidence level for the prediction. Generating the trained machine learning model includes processing, by the computing device, the plurality of prospectuses to generate for each prospectus a text string that captures data of interest including an entity name corresponding to the prospectus. Generating the trained machine learning model also includes parsing, by the computing device, the text strings using a natural language processing technique to generate a plurality of text features and weights corresponding to the plurality of text features. The plurality of text features for each prospectus are correlated to the corresponding classification label. Generating the trained machine learning model further includes training, by the computing device, the machine learning model using the text features and the classification labels to determine mappings between the classification labels and the text features, and validating, by the computing device, the trained machine learning model using test data that comprises a subset of the plurality of prospectuses not used to train the machine learning model.

In another aspect, the invention features a computer-implemented system for validating input data from a third-party vendor. The system comprises an input module configured to receive a plurality of prospectuses from a plurality of third-party entities, a model generator configured to generate a trained machine learning model using the plurality of prospectuses, and an application module configured to apply the trained machine learning model on the input data to predict a classification label for the input data and generate a confidence level for the prediction. The model generator includes a pre-processer configured to process the plurality of prospectuses to generate, for each prospectus, a text string that captures data of interest including an entity name corresponding to the prospectus, and an extractor configured to parse the text strings using a natural language processing technique to generate a plurality of text features and weights corresponding to the plurality of text features. The plurality of text features for each prospectus are correlated to the corresponding classification label. The model generator also includes a training module configured to train the machine learning model using the text features and the classification labels to determine mappings between the classification labels and the text features, and a validator configured to validate the trained machine learning model using test data that comprises a subset of the plurality of prospectuses not used to train the machine learning model.

Any of the above aspects can include one or more of the following features. In some embodiments, the input data comprises financial instrument data. In some embodiments, each classification label indicates an investment category. In some embodiments, the other data of interest for each text string further comprises an objective and a principal investment strategy.

In some embodiments, the natural language processing technique is a term-frequency, inverse document frequency (TF-IDF) technique. In some embodiments, each text feature comprises a term in the corresponding text string and the weight of the text feature quantifies importance of the term in mapping the text feature to a classification.

In some embodiments, the machine learning model is a multi-class classification model. In some embodiments, validating the trained machine learning model further comprises creating a confusion matrix to determine where a mismatch occurs between the model and the test data if a validation confidence level associated with the validating of the trained machine learning model does not satisfy a predefined threshold. In some embodiments, the confusion matrix reveals a degree of match between predicted classification labels and actual classification labels for the test data.

In some embodiments, the predicted classification label is assigned to the input data when the confidence level is above a predetermined threshold.

In some embodiments, the input data includes financial information and a change to a new classification label for the financial information supplied by the third-party vendor. In some embodiments, determination is made regarding whether the predicted classification label agrees with the new classification label. When there is at least one of (i) no agreement between the predicted and new classification label, or (ii) the confidence level for the prediction does not satisfy a predefined threshold, the input data is not processed further.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary diagram of a data validation engine used in a computing system in which changes in data supplied by third party vendors are validated, according to some embodiments of the present invention.

FIG. 2 shows a process diagram of an exemplary computerized method for training an artificial intelligence (AI) model usable for validating data supplied by third party vendors utilizing the computing system and resources of FIG. 1, according to some embodiments of the present invention.

FIG. 3 shows an example of text features and associated weights that correspond to an exemplary classification label, according to some embodiments of the present invention.

FIG. 4 shows an exemplary confusion matrix generated by the validator module of the data validation engine in the computing system of FIG. 1, according to some embodiments of the present invention.

FIG. 5 shows an exemplary data flow diagram corresponding to the exemplary computerized method of FIG. 2 for model training, according to some embodiments of the present invention.

### DETAILED DESCRIPTION

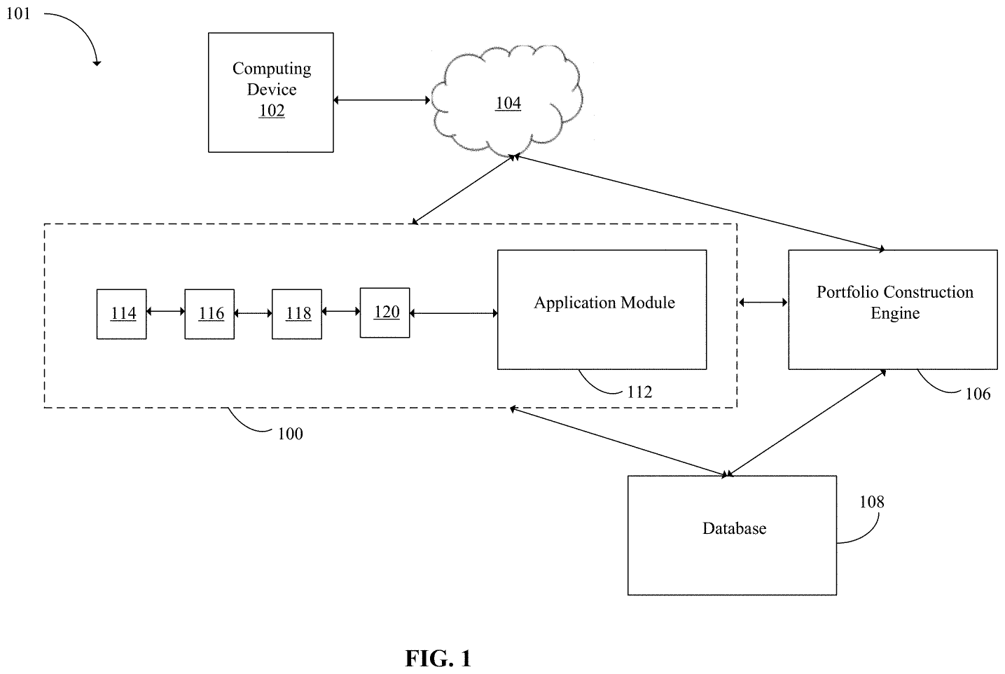

FIG. 1 shows an exemplary diagram of a data validation engine 100 used in a computing system 101 in which changes in data supplied by third party vendors are validated, according to some embodiments of the present invention. As shown, the computing system 101 generally includes one or more databases 108, a communication network 104, the data validation engine 100, and a portfolio construction engine 106. The computing system 101 can also include one or more computing devices 102.

The computing device 102 connects to the communication network 104 to communicate with the data validation engine 100, the database 108, and/or the portfolio construction engine 106 for allowing a user (e.g., a data analyst) to review and visualize results generated by various components of the system 101. For example, the computing device 102 can provide a detailed graphical user interface (GUI) that presents validation results generated by the data validation engine 100, where the GUI can be utilized by the user to review and/or modify the validation results. Exemplary computing devices 102 include, but are not limited to, desktop computers, laptop computers, tablets, mobile devices, smartphones, and internet appliances. It should be appreciated that other types of computing devices that are capable of connecting to the components of the computing system 101 can be used without departing from the scope of invention. Although FIG. 1 depicts a single computing device 102, it should be appreciated that the computing system 101 can include any number of devices.

The communication network 104 enables components of the computing system 101 to communicate with each other to perform the process of data validation and client portfolio construction. The network 104 may be a local network, such as a LAN, or a wide area network, such as the Internet and/or a cellular network. In some embodiments, the network 104 is comprised of several discrete networks and/or sub-networks (e.g., cellular to Internet) that enable the components of the system 100 to communicate with each other.

The data validation engine 100 is a combination of hardware, including one or more processors and one or more physical memory modules and specialized software engines that execute on the processor of the data validation engine 100, to receive data from other components of the computing system 101, transmit data to other components of the computing system 101, and perform functions as described herein. As shown, the processor of the data validation engine 100 executes a pre-processor 114, an extractor module 116, a training engine 118, a validator module 120 and an application module 112. These sub-components and their functionalities are described below in detail. In some embodiments, the various components of the data validation engine 100 are specialized sets of computer software instructions programmed onto a dedicated processor in the data validation engine 100 and can include specifically-designated memory locations and/or registers for executing the specialized computer software instructions.

The database 108 is a computing device (or in some embodiments, a set of computing devices) that is coupled to and in communication with the data validation engine 100 and/or the portfolio construction engine 106 and is configured to provide, receive and store various types of data needed and/or created for performing data validation and client portfolio construction, as described below in detail. In some embodiments, all or a portion of the database 108 is integrated with the data validation engine 100 and/or the portfolio construction engine 106 or located on a separate computing device or devices. For example, the database 108 can comprise one or more databases, such as MySQL™ available from Oracle Corp. of Redwood City, Calif.

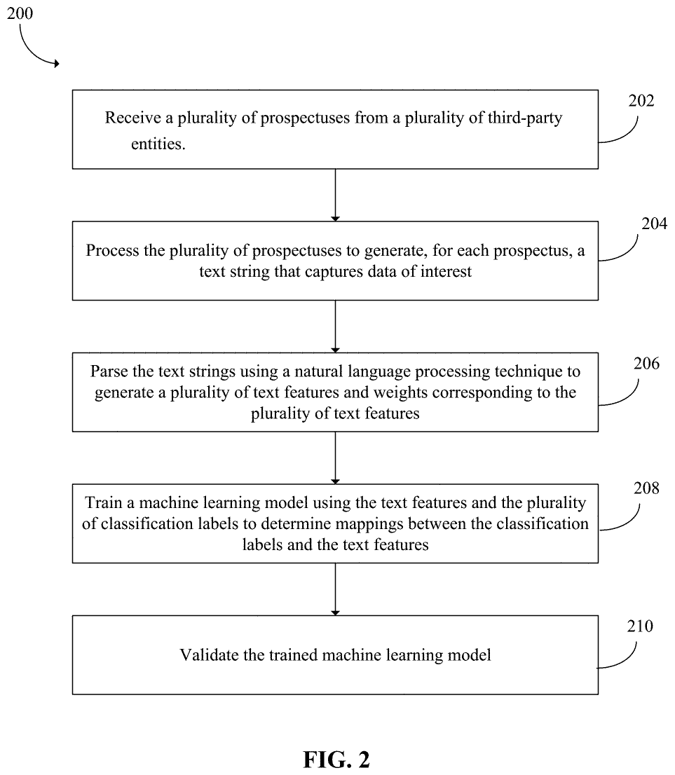

FIG. 2 shows a process diagram of an exemplary computerized method 200 for training an artificial intelligence (AI) model usable for validating data supplied by third party vendors utilizing the computing system 101 and resources of FIG. 1, according to some embodiments of the present invention. The method 200 starts with the data validation engine 100 receiving multiple prospectuses from multiple third party entities at an input module (not shown) of the data validation engine 100. The prospectuses can be divided into two groups for training purposes—one group for training an artificial intelligence (AI) model and another group for testing the trained AI model. The prospectuses are loaded and stored in the database 108 that is readily accessible by the data validation engine 100 and other components of the computing system 100. In some embodiments, each third party entity associated with a prospectus is a financial entity (e.g., a mutual fund, ETF or stock). In some embodiments, the prospectus supplied by each entity comprises financial instrument data. In some embodiments, each third party entity is characterized by a classification label that is present in the corresponding prospectus. An exemplary classification label may be the investment category of the entity (e.g., “large bend” or “small cap”). If a prospectus is used to train and/or test the AI model, it is assumed that the label of the prospectus is accurate (i.e., has been previously validated either manually or automatically). In some embodiments, each prospectus includes a number of key pieces of information useful for training the AI model to automatically identify the classification labels. Such information include the entity name, investment objective and principal investment strategy. Thus, the trained AI model can be used to confirm whether a new incoming prospectus has the correct classification label. In general, the method 200 uses the data set of existing financial entities to train an AI model for the purpose of learning what type of prospectus information matches which classification labels. Thus, in the context of the present invention, a classification label is defined as a data point that encapsulates the information about a prospectus, which the trained AI model is configured to predict. The classification label may or may not be an actual data point present in the prospectus.

At step 204, the pre-processor 114 of the data validation engine 100 is configured to process each prospectus received at step 202 to parse and extract the pertinent data needed for the subsequent training process. For example, the pre-processor 114 can parse each prospectus supplied by an entity to extract certain data of interest including the entity name, investment objective and principal investment strategy associated with the entity that is present in every prospectus. In general, the information extract is useful for training an AI model to predict a classification label for a prospectus. The pre-processor 114 can combine the extracted data into a single text string. In some embodiments, the pre-processor 114 stores these text strings in the database 108.

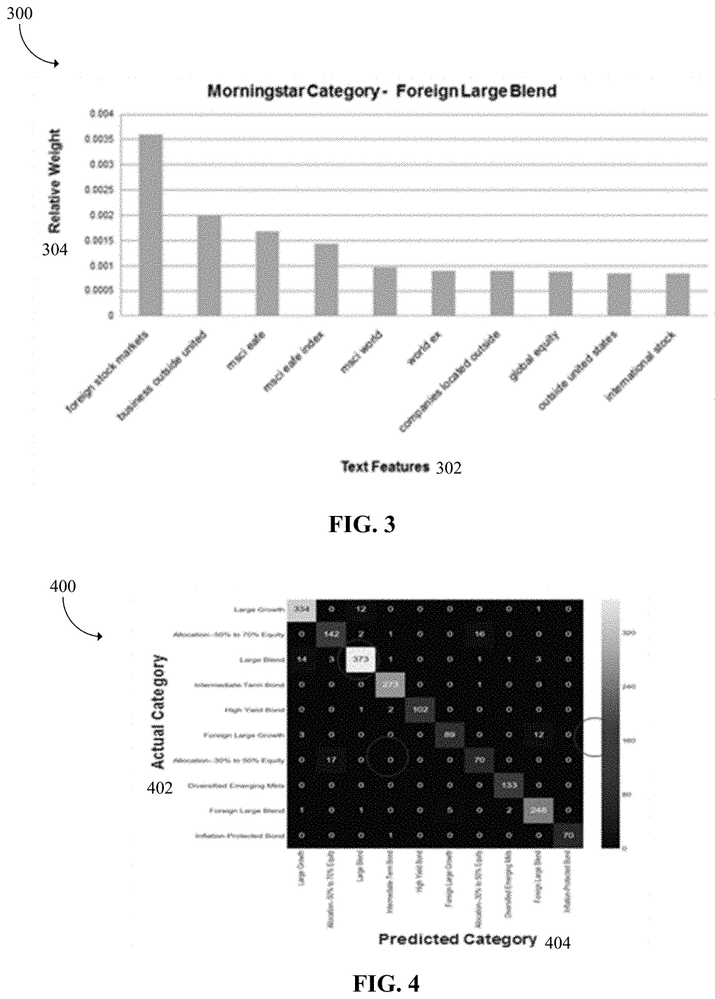

At step 206, the extractor module 116 of the data validation engine 100 is configured to extract certain features from the raw text strings for the prospectuses generated at step 204. For example, the extractor module 116 can use a natural language processing technique to generate these text features, as well as assign weights corresponding to the text features. In some embodiments, the natural language processing technique is a term-frequency, inverse document frequency (TF-IDF) technique. In some embodiments, each text feature includes one or more terms in the corresponding text string and the weight of the text feature quantifies the importance of the term for mapping the text feature to a classification label within a set of preexisting classification labels. FIG. 3 shows an exemplary diagram 300 of text features 302 and associated weights 304 that correspond to the classification label “Foreign Large Blend” 306, according to some embodiments of the present invention. In general, the text features 302 with the highest weights 304 include one or more terms that are more likely to be present in prospectuses for entities associated with the label “Foreign Large Blend” 306 (e.g., entities that invest in international market).

At step 208, the extracted text features and their corresponding weights (from step 206) are used to train an AI model using the training engine 118 of the data validation engine 100. In some embodiments, the AI model is a multi-class classification model or another similar model. Generally, the AI model uses certain terms (i.e. extracted text features) from the prospectus information and their weights in the previous step to learn how to map entity prospectus information (e.g., the extract text features) to classification labels (e.g. investment categories). In some embodiments, the data used to train the AI model at this step is a portion of the overall prospectus data set received (at step 202), such as 66.6% of the overall prospectus data set. The remaining portion of the prospectus data set (e.g., 33.3% of the prospectus data set) is used to test the trained AI model in the subsequent step. Alternatively, a k-fold cross-validation method is used to divide the prospectus data into multiple training and testing data sets, thereby allowing model training and testing over multiple data sets.

At step 210, the validator module 120 of the data validation engine 100 is configured to test the accuracy of the trained AI model from step 208 using the remaining prospectus data set that is set aside for this testing purpose and not used in the training process. During the testing phase, the validator 120 applies the trained AI model to each prospectus in the testing data set to generate a predicted classification label for the prospectus and compare the predicted classification label to the classification label provided in the prospectus to determine if there is a match.

Specifically, the accuracy of the predictions made by the AI model needs to meet or exceed a predefined accuracy threshold. If the model does not meet the predefined accuracy threshold, then the newly trained model is not approved for use in the data validation component by the portfolio construction engine 106. In some embodiments, when the AI model does not meet the predefined threshold, a confusion matrix is created to visually illustrate how the model performed on the test data set. The confusion matrix allows an end user to manually review cases where the model and the actual data do not agree. FIG. 4 shows an exemplary confusion matrix 400 generated by the validator module 120 of the data validation engine 100 of FIG. 1, according to some embodiments of the present invention. As shown, the numbers on the diagonal of the matrix 400 indicate where the actual classification label 402 and the predicted classification label 404 match. The off diagonal numbers in the matrix 400 indicate where the actual classification label 402 and the predicted classification label 404 diverge.

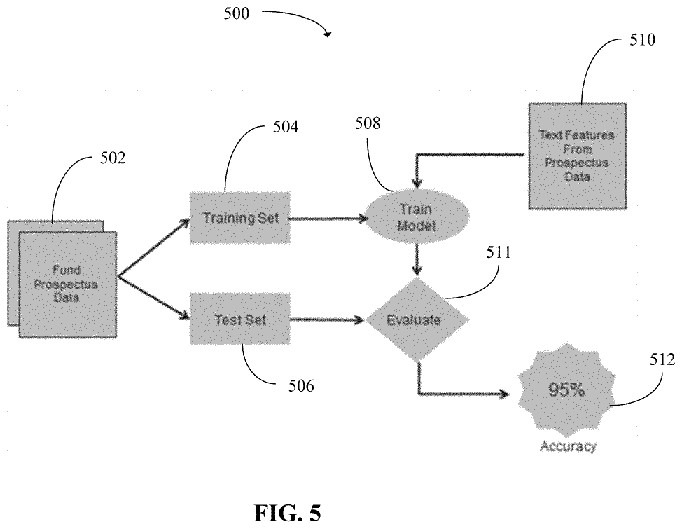

FIG. 5 shows an exemplary data flow diagram 500 corresponding to the exemplary computerized method 200 of FIG. 2 for model training, according to some embodiments of the present invention. As shown, the prospectus data 502 used to generate the AI model can be divided into two groups—the training data set 504 and the testing data set 506 in a manner as described above with respect to FIG. 2. The training data set 504 is used by the training engine 118 of the data validation engine 100 to train the AI model 508 (at step 208 of method 200 of FIG. 2). As described above, the training approach can be based on a multiclass classification approach using specific text features and their corresponding weights 510 extracted from the training data set 504 by the extractor module 116 of the data validation engine 100 (at step 206 of method 200 of FIG. 2). The test data set 506 can be used to test/evaluate 511 the trained model using the validator module 120 of the data validation engine 100 (at step 210 of method 200 of FIG. 2) to determine a percentage of accuracy 512 of the trained model.

In some embodiments, the AI model of method 200 and data flow 500 is used to train/refine the model on a periodic basis to ensure its accuracy. For example, the training can be done on a daily basis because i) the universe of prospectus information handled by an organization can change every day e.g. as new funds are added; ii) the computing system 100 may receive updated prospectus data on any day, which the organization may want to model and account for on that day; and iii) the classification labels can be updated on any day, which may necessitate the re-training of the AI model to take the updates into account.

In some embodiments, the data set 502 is loaded from third-party vendor databases into the database 108 of system 101 prior to model training. In some embodiments, any intermediate data generated by the model training process 200 is also stored in the database 108, such as the extracted text features and their corresponding weights, the trained model, the confusion matrix, etc.

In another aspect, the application module 112 of the data validation engine 100 of FIG. 1 is configured to automatically validate a new incoming prospectus using the trained model generated by the process 200 of FIG. 2. In general, the application module 112 can inspect data flow through the computing system 100 and apply relevant data (e.g., financial prospectus data) as input to the trained AI model to determine if information supplied by third party vendors is valid for use in constructing a new portfolio for clients. Specifically, the application module 112 can predict a classification label for an incoming prospectus by inputting certain prospectus information (e.g., a combination of entity name, the investment objective and the principal investment strategy of the entity) into the trained AI model. The application module 112 can also present the prediction to a user on graphical user interface via the client computing device 102 of the user. In some embodiments, the incoming prospectus is a part of the data flow to the portfolio construction engine 106 and include a change in its classification label supplied by the third party vendor that requires validation. In some embodiments, the application module 112 can validate the classification label in the incoming prospectus as soon as it enters the model building phase of the workflow.

Further, the application engine 112 can be configured to ensure that the data in the incoming prospectus is deemed valid before supplying it to the portfolio construction phase of the portfolio construction engine 106. Such validity can be established based on at least one of (i) the predicted classification label of the incoming prospectus matching the label provided in the prospectus by the vendor, or (ii) a confidence level of the model prediction exceeding a confidence threshold (e.g., 90%). In some embodiments, both conditions need to be satisfied to ensure that the data in the incoming prospectus is valid. In some embodiments, only one of the conditions needs to be satisfied to ensure that the data in the incoming prospectus is valid. In some embodiments, if both conditions are not satisfied, the data is deemed invalid. In some embodiments, the confidence threshold is different for different classification labels (e.g., investment category) based on historical analysis. Therefore, the data validation engine 100 can be a key component of the portfolio construction process implemented by the portfolio construction engine 106.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computer-implemented method for validating input data from a third-party vendor, the method comprising:
receiving, by a computing device, a plurality of prospectuses from a plurality of third-party entities;
generating, by the computing device, a trained machine learning model using the plurality of prospectuses, generating the trained machine learning model comprising:
processing, by the computing device, the plurality of prospectuses to generate, for each prospectus, a text string that captures data of interest including an entity name corresponding to the prospectus;
parsing, by the computing device, the text strings using a natural language processing technique to generate a plurality of text features and weights corresponding to the plurality of text features, wherein the plurality of text features are correlated to respective ones of a plurality of classification labels;
training, by the computing device, the machine learning model using the text features and the plurality of classification labels to determine mappings between the classification labels and the text features; and
validating, by the computing device, the trained machine learning model using test data that comprises a subset of the plurality of prospectuses not used to train the machine learning model; and
applying, by the computing device, the trained machine learning model on the input data to predict a classification label for the input data and generate a confidence level for the prediction.

2. The computer-implemented method of claim 1, wherein the input data comprises financial instrument data.

3. The computer-implemented method of claim 1, wherein each classification label indicates an investment category.

4. The computer-implemented method of claim 1, wherein the data of interest for each text string further comprises an objective and a principal investment strategy.

5. The computer-implemented method of claim 1, wherein the natural language processing technique is a term-frequency, inverse document frequency (TF-IDF) technique.

6. The computer-implemented method of claim 1, wherein each text feature comprises a term in the corresponding text string and the weight of the text feature quantifies importance of the term in mapping the text feature to a classification label.

7. The computer-implemented method of claim 1, wherein the machine learning model is a multi-class classification model.

8. The computer-implemented method of claim 1, wherein validating the trained machine learning model further comprises creating a confusion matrix to determine where a mismatch occurs between the model and the test data if a validation confidence level associated with the validating of the trained machine learning model does not satisfy a predefined threshold.

9. The computer-implemented method of claim 8, wherein the confusion matrix reveals a degree of match between predicted classification labels and actual classification labels for the test data.

10. The computer-implemented method of claim 1, further comprising assigning the predicted classification label to the input data when the confidence level is above a predetermined threshold.

11. The computer-implemented method of claim 1, wherein the input data includes financial information and a change to a new classification label for the financial information supplied by the third-party vendor.

12. The computer-implemented method of claim 11, further comprising:
determining whether the predicted classification label agrees with the new classification label; and
stop processing the input data when there is at least one of (i) no agreement between the predicted and new classification label, or (ii) the confidence level for the prediction does not satisfy a predefined threshold.

13. A computer-implemented system for validating input data from a third-party vendor, the system comprising:
an input module configured to receive a plurality of prospectuses from a plurality of third-party entities;
a model generator configured to generate a trained machine learning model using the plurality of prospectuses, the model generator comprising:
a pre-processer configured to process the plurality of prospectuses to generate, for each prospectus, a text string that captures data of interest including an entity name corresponding to the prospectus;
an extractor configured to parse the text strings using a natural language processing technique to generate a plurality of text features and weights corresponding to the plurality of text features, wherein the plurality of text features for each prospectus are correlated to the corresponding classification label;
a training module configured to train the machine learning model using the text features and the classification labels to determine mappings between the classification labels and the text features; and
a validator configured to validate the trained machine learning model using test data that comprises a subset of the plurality of prospectuses not used to train the machine learning model; and
an application module configured to apply the trained machine learning model on the input data to predict a classification label for the input data and generate a confidence level for the prediction.

14. The computer-implemented system of claim 13, wherein each classification label indicates an investment category.

15. The computer-implemented system of claim 13, wherein the natural language processing technique is a term-frequency, inverse document frequency (TF-IDF) technique.

16. The computer-implemented system of claim 13, wherein each text feature comprises a term in the corresponding text string and the weight of the text feature quantifies importance of the term in mapping the text feature to a classification label.

17. The computer-implemented system of claim 13, wherein the validator is further configured to create a confusion matrix to determine where a mismatch occurs between the machine learning model and the test data if a validation confidence level generated from the validation of the trained machine learning model does not satisfy a predefined threshold.

18. The computer-implemented system of claim 13, wherein the application module is further configured to assign the predicted classification label to the input data when the confidence level is above a predetermined threshold.

19. The computer-implemented system of claim 13, wherein the input data includes financial information and a change to a new classification label for the financial information supplied by the third-party vendor.

20. The computer-implemented system of claim 13, wherein the application module is further configured to:
determine whether the predicted classification label agrees with the new classification label; and
stop processing the input data when there is at least one of (i) no agreement between the predicted and new classification label, or (ii) the confidence level for the prediction does not satisfy a predefined threshold.
